(19) United States
(12) Patent Application Publication
(10) Pub. No.: US 2014/0191533 A1
(43) Pub. Date: Jul. 10, 2014

(54) VEHICLE INTERIOR TRIM

(71) Applicant: Masahito Takahashi, Kasugai-shi (JP)

(72) Inventor: Masahito Takahashi, Kasugai-shi (JP)

(73) Assignee: HOWA TEXTILE INDUSTRY CO., LTD, Aichi (JP)

(21) Appl. No.: 13/806,792

(22) PCT Filed: Jun. 20, 2011
(86) PCT No.: PCT/JP2011/064043

§ 371 Date: Feb. 1, 2013

(30) Foreign Application Priority Data
Aug. 3, 2010 (JP) 2010-174523

(51) Int. Cl. B60R 13/02; B60R 21/04

(52) U.S. Cl. CPC B60R 13/02; B60R 21/04
USPC 296/187.05

(57) ABSTRACT

Provided is a pillar trim (30) (a vehicle interior trim) with a main body part (32) formed in a hollow, three-dimensional structure by a thermoplastic synthetic resin. The exterior surface of the main body part (32) has a structure whereby an attachment surface (32a) attached to a vehicle structural member and a design surface (32b) inside the vehicle which are both joined together. In addition, the main body part (32) is formed of a bag-like construction that restricts the flow of internal air to the outside, and the main body part (32) distributes and absorbs impact forces from passenger during vehicle impact by using the internal pressure thereof.

### TECHNICAL FIELD

The present invention relates to vehicle interior trims, particularly, to vehicle interior trims that are placed on a vehicle interior side of each vehicle structural member and which a passenger might contact during a possible vehicle impact.

### BACKGROUND ART

Conventionally, major vehicle structural members defining a vehicle interior of a vehicle are doors and side panels, etc. Typically, a roof panel as vehicle panel is placed above the doors and the side panels. Pillars are provided as supporting members for supporting the roof panel. Most of these vehicle structural members are made from metal plates (e.g., steel plate). Accordingly, vehicle interior trims are equipped on interior sides of the vehicle structural members in order to cover the vehicle structural members and constitute an inwardly facing surface of the vehicle interior. The vehicle interior trims correspond to the vehicle structural members, so that door trims and side panel trims are placed on the interior side of the doors and the side panels of the vehicle, respectively. Pillar trims are placed on the interior side of the pillars of the vehicle. A headliner is provided on the interior side of the roof panel of the vehicle.

These vehicle interior trims have a role as a design surface for making the inwardly facing surface of the vehicle interior smooth in addition to covering the vehicle structural members. They are typically made from a combination of synthetic resins and fiber materials, etc. Since a passenger might collide against the vehicle interior trims during vehicle impact, they are preferably shaped to absorb impact forces from the passenger during vehicle impact in order to protect the passenger. For example, Patent Documents 1-5 disclose techniques as examples of vehicle interior trims each having such shock absorbing configuration.

Patent Documents 1 and 2 disclose techniques relating to a shock absorber for a vehicle, which is formed in a hollow shape by blow molding of thermoplastic materials. The shock absorber for the vehicle of Patent Document 1 has a concave-shaped rib that is inwardly bent, and its method absorbs shock due to the plastic deformation of the concave-shaped rib. Similarly, the shock absorber for the vehicle of Patent Document 2 has concave-shaped ribs that are inwardly bent and a groove-like rib connecting the concave-shaped ribs. Similarly, its technique for absorbing shock due uses the plastic deformation of both ribs. Patent Document 3 discloses a configuration for a shock absorber for absorbing impact forces from the passenger during vehicle impact disposed between a vehicle structural member and a vehicle interior trim placed on an interior side of the vehicle structural member. Patent Document 4 discloses, with respect to a trim placed on an interior side of a vehicle structural member, a shock absorbable trim having a plurality of flat-plate ribs arranged in a lattice pattern on a surface to be attached to the vehicle structural member. Patent Document 5 discloses a trim placed on an interior side of a vehicle structural member and having a shock absorption portion with an air conditioning duct.

### PRIOR ART DOCUMENTS

### Patent Documents

Patent Document 1: JP 2000-108826 A
Patent Document 2: JP2006-151250 A
Patent Document 3: JP06-211088 A
Patent Document 4: JP11-170943 A
Patent Document 5: JP2005-96612 A

### DISCLOSURE OF THE INVENTION

### Problems to be Solved by the Invention

With respect to the shock absorbers for the vehicle, which are disclosed in Patent Documents 1 and 2, it is necessary to form the rib(s) at a position whereby they can absorb impact forces from the passenger during vehicle impact. However, since there might be a wide variety of movements of the passenger colliding against the vehicle structural members during vehicle impact, it is not easy to decide the position of the trim. In addition, such shock absorbers are configured as separate members housed in the trim covering the vehicle structural member. Problems arise due to the large number of components. Such numerous materials make total weights heavy and manufacturing costs high. With respect to the technique disclosed in Patent Document 3, since its absorption member is configured as separate members from the trim similar to Patent Document 1, there are problems that because the number of structural members is large, its weight becomes heavy and its material cost becomes high. With respect to the technique disclosed in Patent Document 4, it is necessary to form the rib at an effective position in order to adequately absorb the impact forces from the passenger during vehicle impact similar to Patent Document 1. However, since there might be a wide variety of movements of the passenger colliding against the vehicle structural member during vehicle impact, it is not easy to decide the position of the trim. Additionally, since the lattice-shaped ribs are formed on the attachment surface, the entirety of the structure becomes complex. So, there are problems that production costs becomes high and its weight becomes heavy. With respect to the technique disclosed in Patent Document 5, since the shock absorption portion doubles as air conditioning duct, it is necessary to meet two requirements for both air conditioning duct and shock absorber. The arrangement of both such features may prove difficult.

Accordingly, with respect to the vehicle interior trim that is placed on the interior side of the vehicle structural member and that the passenger contacts during vehicle impact, there have been requirements for providing the vehicle interior trim being inexpensive, light weight and being capable of adequately absorbing impact forces from the passenger during vehicle impact.

### Means For Solving The Problem

In order to solve the above-described problems, the vehicle interior trim of this disclosure has the following means.

In a first aspect of this disclosure, the vehicle interior trim is a member that a passenger might contact during vehicle impact and is placed on an interior side of a vehicle structural member. This vehicle interior trim has a main body part formed in a hollow shape and made from thermoplastic synthetic resins. The main body part is configured such that an exterior surface thereof has an attachment surface to be attached to the vehicle structural member and a design surface inside a vehicle, which are joined together. In addition, the main body part is formed in a bag-like construction restricting the flow of internal gas to the outside, and thus can distribute and absorb impact forces from the passenger during vehicle impact by using internal pressure of the main body part.

According to the above-mentioned configuration, the vehicle interior trim has the main body part formed in a hollow shape and made from thermoplastic synthetic resins. Since this main body part is formed in a hollow shape, it is able to reduce its weight. In addition, the main body part is configured such that its exterior surface has the attachment surface attached to the vehicle structural member and the design surface inside of the vehicle, which are joined together. That is, the main body part doubles as a conventional trim member constituting the design surface and also has a role as shock absorber for absorbing impact forces from the passenger during vehicle impact. This can make the number of members small and thus reduce material cost. The main body part is formed in the bag-like shape restricting the flow of the internal gas to the outside and distributes and absorbs the impact forces from the passenger during vehicle impact by using the internal pressure of the main body part. In a conventional shock absorber, since there is a wide variety of movement of the passenger colliding against the vehicle structural member during vehicle impact, it is not easy to decide a position of the conventional shock absorber configured to absorb the impact forces from the passenger during vehicle impact. Meanwhile, this main body part is configured as a hollow structure and is formed in the bag-like construction restricting the flow of the internal gas to the outside. Pressure of the internal gas evenly acts outwardly at all regions of an exterior surface of the main body part. Accordingly, whichever place of the main body part in the bag-like shape the passenger collides against during vehicle impact, it is able to adequately absorb the impact forces. That is, whole area of the design surface of the main body part is formed as surface capable of absorbing shock. Compressibility of gas is suitable for shock absorption very well. When the impact forces from the passenger act on the main body part, the impact forces are distributed by using the flow of the internal gas. So, it is able to adequately absorb the impact forces from the passenger during vehicle impact furthermore.

In a second aspect of this disclosure, the vehicle interior trim according to the first aspect is further modified such that the exterior surface of the main body part has at least one vent allowing the internal gas to flow outside when the impact forces from the passenger act on the main body part during vehicle impact.

According to the above-mentioned configuration, it is desired that at least one vent allowing the internal gas of the main body part to flow outside is formed as configuration to restrict the flow of the internal gas of the main body part to the outside. This can further absorb the impact forces when the impact forces from the passenger act on the main body part of the vehicle interior trim during vehicle impact by utilizing the flow resistance of the internal gas of the main body part, which flows through the vent toward the outside.

### Effect of the Invention

According to the above-described configurations, it is able to achieve lighter weight, lower cost and adequately absorb the impact forces from the passenger during vehicle impact with respect to the vehicle interior trims that a passenger may contact during vehicle impact and is placed on the interior side of the vehicle structural member.

### BRIEF DESCRIPTION OF THE DRAWINGS

FIG. 1 is a perspective view showing a state that a vehicle interior rim according to a first embodiment is attached to a vehicle;

FIG. 2 is a cross-sectional view along line in FIG. 1;

FIG. 3 is a schematic process drawing showing a molding process of the main body part of the vehicle interior trim according to the first embodiment, wherein A is a view showing a step of positioning a pair of molds in an open state and placing a parison therebetween as a previous step in such molding, B is a view showing a step of closing the molds into a closed state, C is a view showing a step of introducing air through a blowing opening in order to expand and press the parison against an inwardly facing surfaces of the molds, and D is a view showing a step of opening the molds in order to take the main body part, which has been hardened by cooling, from the molds; and

FIG. 4 is a cross-sectional view corresponding to FIG. 2 of the vehicle interior trim according to a second embodiment.

### EMBODIMENTS FOR CARRYING OUT THE INVENTION

Hereafter, embodiments for carrying out this disclosure will be described by reference to the drawings.

### First Embodiment

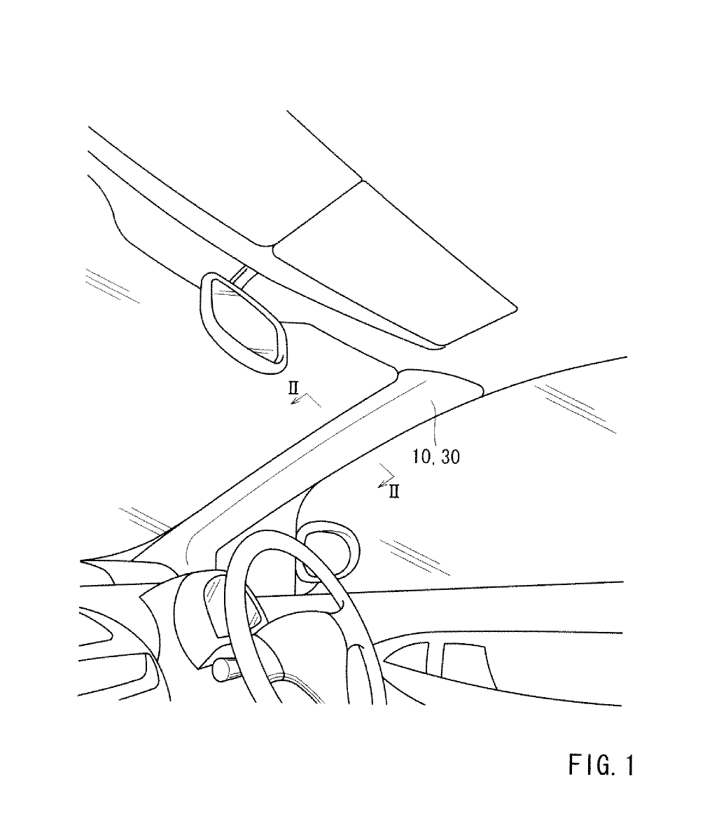

At first, a configuration of the vehicle interior trim according to the first embodiment will be described by reference to FIGS. 1-4. The vehicle interior trim of this embodiment is placed on the interior side of the vehicle structural member to constitute an inwardly facing wall of the vehicle interior. An example thereof is a door trim or a side panel trim that is placed on the interior side of the door or the side panel of the vehicle. it may be configured as a vehicle structural member, a pillar trim placed on the interior side of a vehicle pillar (vehicle structural member), or a head liner paced on the interior side of a vehicle roof panel (vehicle structural ember), etc.

As shown in FIG. 1, this embodiment will be described while illustrating a configuration wherein a pillar trim 30 is used as the vehicle interior trim. The pillar trim is typically placed on the interior side of a vehicle structure member known as a pillar. The pillar configured as the vehicle structural member may be located between a main portion of a vehicle body and the roof panel configured as vehicle root'. The pillar supports the roof panel. The pillar may be an A-pillar placed diagonally to the front of a front seat of the vehicle, a B-pillar placed between the front seat and a rear seat, a C-pillar placed diagonally to the rear of the rear seat or the like. In this embodiment, an A-pillar 10 will be described as a representative of such a pillar formed as vehicle structural member.

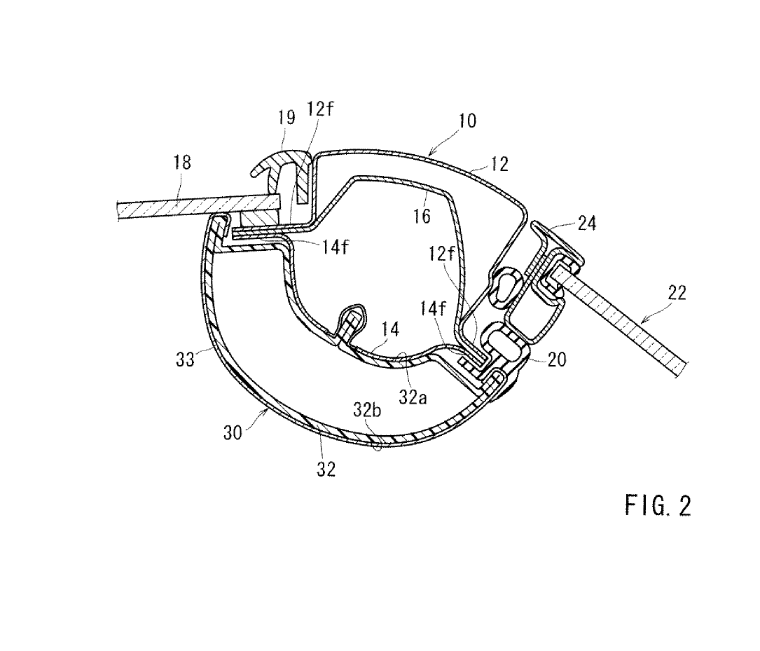

As shown in FIG. 2, the A-pillar 10 (vehicle structural member) consists of three members: an outer panel 12 and an inner panel 14, both of which are made of a steel plate, and a metal reinforcement member 16. The outer panel 12 is a member constituting an exterior surface of the vehicle. The inner panel 14 is placed inside of the vehicle and is configured to define the vehicle interior. The metal reinforcement member 16 is a reinforcing material for improving the rigidity of the outer panel 12 and the inner panel 14. This A-pillar 10 (vehicle structural member) is configured as a closed cross-sectional structure. It is formed by joining flanges 12f and 14f that are formed at both ends of the outer panel 12 along with the inner panel 14 by spot-welding in a state that the metal reinforcement member 16 is positioned between the outer panel 12 and the inner panel 14. The flanges 12f and 14f of one end of the A-pillar 10 (vehicle structural member) are provided with an end of a windshield 18. A garnish 19 fills a gap between the outer panel 12 and the windshield 18 in order to support the windshield 18. The flanges 12f and 14f of the other end of the A-pillar 10 (vehicle structural member) are provided with a door-sealing member 20. When closing a front door 22, this door-sealing member 20 tightly contacts a doorframe in a sealing manner. A pillar trim 30 (vehicle interior trim) is placed on the interior side of the A-pillar 10 (vehicle structural member).

As shown in FIG. 2, this pillar trim 30 (vehicle interior trim) is placed on the interior side of the A-pillar 10 (vehicle structural member).

This pillar trim 30 (vehicle interior trim) is made from thermoplastic synthetic resins and is integrally molded. by blow molding. This pillar trim 30 (vehicle interior trim) includes a main body part 32 formed in a hollow shape. With respect to an exterior surface of the main body part 32, an attachment surface 32a (to be attached to the vehicle structural member) and a design surface 32b inside of the vehicle are positioned in an opposing manner to each other and are integrally molded in a hollow three-dimensional structure. This hollow-shaped main body part 32 is made from thermoplastic resins and is formed in a bag-like construction configured to restrict the flow of internal gas to the outside. In outer edges of the attachment surface 32a and the design surface 32b of the main body part 32 are stacked and are joined in order to form the closed cross-sectional structure.

Materials having high mechanical strength, which include, for example, polyolefins such as polyethylene and polypropylene, styrene (co)polymers such as polystyrene and ABS resin, polyesters such as polyethylene terephthalate and polyamide, are used as thermoplastic synthetic resins for this pillar trim 30 (vehicle interior trim). Average wall thickness of the pillar trim 30 (vehicle interior trim) is, in light of provision of soft feeling of its surface and mechanical strength, preferably between 0.3 mm and 3.2 mm. When the thickness is below 0.3 mm, its mechanical strength is insufficient. While, when the thickness is above 3.2 mm, it is not able to provide a soft feeling to its surface.

[With Regard to the Method of Production of the Pillar Trim 30 (Vehicle Interior Trim)]

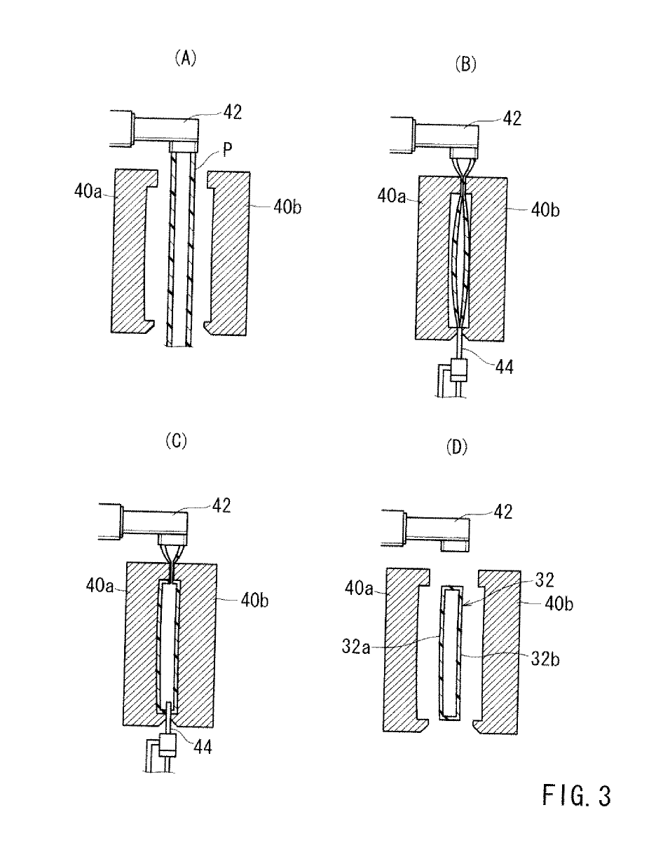

As mentioned above, blow molding will be exemplified and described with respect to molding of the pillar trim 30 (vehicle interior trim) formed in the hollow shape. Although blow molding is shown here, the method is not limited to blow molding. The pillar trim 30 (vehicle interior trim) of this disclosure only has to be made from thermoplastic synthetic resins and formed in the hollow shape. It can be molded by gas injection or can be formed in the hollow shape by stacking and joining plate-shaped members made from thermoplastic synthetic resins. A shape of the pillar trim 30 shown in FIG. 3 is different from that shown in FIG. 2 and is shown as a schematic shape in order to make explanation of its formation more understandable.

As shown in FIGS. 3A-3D, this blow molding is molding method by sandwiching a pipe (parison) made from thermoplastic resins between molds, injecting air therein in order to expand and tightly contact it with inwardly facing surfaces of the molds, cooling it for curing, and then taking it out. As shown in FIG. 3A, as a preliminary step toward molding, a pair of molds 40a and 40b are opened. Thermoplastic synthetic resins that have been plastically deformable by an extruder are extruded through a die 42 to form a parison P. The parison P is positioned between the molds 40a and 40b. Here, the molds 40a and 40b are formed such that the configuration of an inside space thereof in a closed state corresponds to the shape of the main body part 32 of the pillar trim 30 (vehicle interior trim). Roughly speaking, a molding surface of one mold 40a forms an outer shape of the attachment surface 32a, while a molding surface of the other mold 40b forms an outer shape of the design surface 32b. The die 42 is a member for shaping thermoplastic resins, which have been plastically deformable and are extruded into the pipe-shaped parison P. The die 42 generally refers to an outlet (nozzle) of the extruder, which determines a final shape of the parison P.

As shown in FIGS. 3B and 3C, the parison P is sandwiched between the molds 40a and 40b. An upper end and a lower end of the parison P are closed by closing the molds. Air is introduced into the parison P through an air injection opening 44 (nozzle or needle) positioned at a mating surface of the closed molds 40a and 40b. The parison P is expanded and pressed against the inwardly facing surfaces of the molds 40a and 40b. The parison P is stretched and pressed against the molds in order to harden it and form the hollow-shaped main body part 32. Here, this main body part 32 is formed in a bag-like construction by tightly closing and cooling it for hardening in a condition where a predetermined amount of compressed air is introduced into it in the air introduction step. After hardening through the cooling step, as shown in FIG. 3D, the pillar trim 30 (vehicle interior trim) is completed by opening the molds 40a and 40b, taking the main body part 32 out, and then laying a surface member 33 on the design surface 32b. Here, the design surface 32b of the main body part 32 may be constructed. as an outwardly facing surface without having the surface member 33.

In this manner, the pillar trim 30 (vehicle interior trim) according to the first embodiment has a main body part 32 that is made from thermoplastic synthetic resins and is formed in the hollow three-dimensional structure. Since this main body part 32 is configured in a hollow shape, its weight can be reduced. The main body part 32 is configured such that its outer surface has an attachment surface 32a to be attached to the A-pillar 10 (vehicle structural member). It is also joined to the design surface 32b facing the vehicle interior. That is, the main body part 32 acts as a shock absorber for absorbing impact forces from the passenger during vehicle impact and doubles as the design surface 32b for conventional vehicle trim. This makes the number of components smaller and thus can decrease production cost. The main body part 32 is formed in a bag-like shape restricting the flow of internal gas to the outside, and is configured to distribute and absorb the impact forces from the passenger during vehicle impact due to internal pressure of the main body part 32. In a conventional shock absorber, there are a wide variety of movements of a passenger colliding toward a vehicle structural member during vehicle impact, and thus it is not easy to determine a position of the conventional shock absorber for absorbing the impact forces from the passenger during vehicle impact. Meanwhile, this main body pan 32 is configured in a hollow shape and is formed in a bag-like shape restricting the flow of the internal gas to the outside. Since pressure of the internal gas generally acts evenly on all positions of the outer surface of the main body part 32 outwardly, it is able to appropriately absorb the impact forces despite whichever position of the main body part 32 in a bag-like shape that a passenger collides with near the vehicle structural member during vehicle impact. That is, substantially the entire surface of the design surface 32b of the main body part 32 is configured to be capable of absorbing shock. And, compressible nature of gas is suitable for shock absorption very well. When the impact forces from the passenger act on the main body part 32, the impact forces are distributed due to the flow of the internal gas. In this way, it is able to properly absorb the impact forces from the passenger during vehicle impact.

Conventionally, in order to give a soft feeling to a surface of the design surface 32b of the trim member, the design surface 32b is covered with the surface member such that a pad layer such as polypropylene foam or polyethylene foam is sandwiched therebetween. Meanwhile, since the pillar trim 30 (vehicle interior trim) is configured in the hollow shape, it is able to give a moderately soft feeling to the design surface 32b. Consequently, if the surface member 33 is directly attached to it, the soft feeling of the surface is not impaired. In addition, since the pillar trim 30 (vehicle interior trim) according to this embodiment is configured as a bag-like construction (in other words, closed cross-sectional structure) restricting the flow of the internal gas to the outside, it is able to achieve high rigidity.

### Second Embodiment

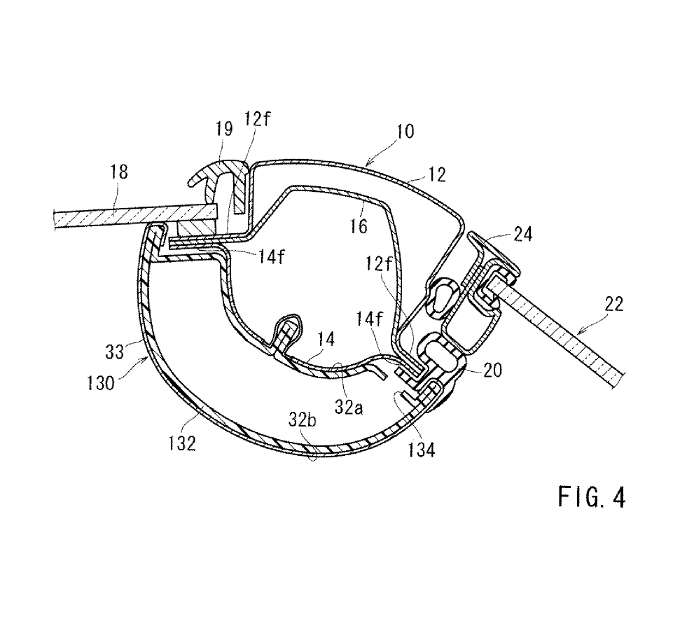

Next, a pillar trim 130 (vehicle interior trim) according to a second embodiment of this disclosure will be described by reference to FIG. 4. The same components with those of the first embodiment are labeled with the same reference numbers and explanation thereof will be omitted. In this second embodiment, a configuration restricting the flow of the internal gas to the outside is different from that of the first embodiment. In detail, the pillar trim 30 of the first embodiment is configured in the bag-like construction in a sealed manner. The outer edges of the attachment surface 32a and the design surface 32b of the main body part 32 of the pillar trim 30 are stacked and joined in order to restrict the flow of the internal gas to the outside.

Meanwhile, in the second embodiment in which the above-described configuration. has been changed, the pillar trim 130 (vehicle interior trim) may have the below described features.

As shown in FIG. 4, at least one vent 134 is formed in the outer surface of the main body part 132 as a configuration restricting the flow of the internal gas to the outside. This can allow the internal gas to flow outside when the impact forces from the passenger during vehicle impact act on the main body part 132. Diameter of the vent 134 is preferably between 1 mm and 2 mm. Other configurations are the same as those of the first embodiment. Due to the above-described configuration, the pillar trim 130 (vehicle interior trim) can fulfill the same function and have the same effect with the first embodiment. It can further absorb shock when the impact forces from the passenger during vehicle impact act on the main body part 132 of the pillar trim 130 (vehicle interior trim). This further shock absorbance is due to flow resistance of the internal gas of the main body part 132, which flows outside though the vent 134.

Additionally, although the first and the second embodiments have been described as examples of this disclosure, the vehicle interior trim of this disclosure is not limited to the embodiments and other various embodiments can be carried out.

1. (canceled)

2. (canceled)

3. A vehicle interior trim that is placed on an interior side of a vehicle structural member, comprising:
a main body part made from thermoplastic synthetic resin and formed in a closed hollow shape restricting the flow of an internal gas to the outside, the main body part having an attachment surface to be attached to a vehicle structural member and a design surface for a vehicle interior;
wherein the entire outer edges of the attachment surface and the design surface are joined together in a sealed manner such that the entire surface of the design surface is configured to absorb impact forces.

4. The vehicle interior trim according to claim 3, wherein average wall thickness of the main body part is between 0.3 mm and 3.2 mm.

5. The vehicle interior trim according to claim 3, wherein internal pressure of the main body part is higher than atmospheric pressure.
